(19) United States
(12) Patent Application Publication
(10) Pub. No.: US 2017/0302971 A1
(43) Pub. Date: Oct. 19, 2017

(54) DELIVERY OF MEDIA CONTENT AND ASSOCIATED METADATA USING A BONDED CELLULAR SYSTEM

(71) Applicant: Tribune Broadcasting Company, LLC, Chicago, IL (US)

(72) Inventors: Hank J. HUNDEMER, Bellevue, KY (US); Dana A. LASHER, Morgan Hill, CA (US)

(21) Appl. No.: 15/488,268

(22) Filed: Apr. 14, 2017

Related U.S. Application Data
(60) Provisional application No. 62/323,440, filed on Apr. 15, 2016.

(51) Int. Cl. H04N 21/234; H04N 21/235; H04N 21/236; H04N 21/262; H04N 21/41; H04W 84/04

(52) U.S. Cl. CPC H04N 21/234; H04N 21/262; H04N 21/4126; H04N 21/2353; H04N 21/236; H04W 84/042

(57) ABSTRACT

In one aspect, a bonded cellular system includes a client in communication with a transmitter having a number of cellular modems and a server in communication with a receiver. A file can be transmitted from the client to the server by parsing the file into data packets and dividing transmission of the packets among the number of cellular modems. One of the cellular modems can act as an internet access point for the client, through which the client can send metadata associated with the file to the server. Based on the received metadata, the server can perform various operations on the received file. In one embodiment, the file can include media content, and, based on the metadata, a server of a media-broadcasting system can associate the media content with a particular story of a rundown for a television news broadcast.

### RELATED DISCLOSURES

This disclosure claims priority to U.S. Provisional Patent Application No. 62/323,440, titled “Delivery of Media Content and Associated Metadata Using a Bonded Cellular System,” filed on Apr. 15, 2016, which is hereby incorporated by reference in its entirety.

### USAGE AND TERMINOLOGY

In this disclosure, unless otherwise specified and/or unless the particular context clearly dictates otherwise, the terms “a” or “an” means at least one, and the term “the” means the at least one.

### BACKGROUND

Unless otherwise specified, the materials described in this section are not prior art and are not admitted to be prior art by inclusion in this section.

A bonded cellular system can perform various acts and/or functions related to transmitting data over one or more cellular networks. For example, a bonded cellular system can transmit video content over one or more cellular networks to a video-production system (VPS). A VPS can perform various acts and/or functions related to video content. For example, a VPS can receive, generate, and/or output video content.

### SUMMARY

In one aspect, an example method is disclosed. The method includes (i) receiving, by a computing system, media content via a plurality of bonded cellular networks; (ii) receiving, by the computing system, metadata associated with the media content via one or more communication networks distinct from the plurality of bonded cellular networks; and (iii) using, by the computing system, the received metadata to generate a video stream representing video content that includes at least a portion of the received media content.

In another aspect, an example computing system is disclosed. The computing system includes (i) a first communication interface for receiving media content via a plurality of bonded cellular networks; (ii) a second communication interface for receiving metadata associated with the media content via one or more communication networks distinct from the plurality of bonded cellular networks; and (iii) one or more processors configured to use the received metadata to generate a video stream representing video content that includes at least a portion of the received media content.

In another aspect, an example computing system is disclosed. The computing system includes (i) a transmitter system configured to (a) obtain media content and metadata associated with the media content, (b) parse the obtained media content into a plurality of data packets, (c) transmit the plurality of data packets via a plurality of bonded cellular networks, and (d) transmit the obtained metadata via one or more communication networks distinct from the plurality of bonded cellular networks; and (ii) a receiver system configured to (a) receive the transmitted plurality of data packets via the plurality of bonded cellular networks, (b) reconstruct the media content using the received plurality of data packets, (c) receive the transmitted metadata via the one or more communication networks distinct from the plurality of bonded cellular networks, and (d) use the received metadata to generate a video stream representing video content that includes at least a portion of the reconstructed media content.

### BRIEF DESCRIPTION OF THE DRAWINGS

FIG. 1 is a simplified block diagram of an example computing device.

FIG. 2 is a simplified block diagram of an example bonded cellular system.

FIG. 3 is a simplified block diagram of an example video system.

FIG. 4 is a simplified block diagram of an example VPS.

FIG. 5A is a simplified diagram of an example frame of video content, without content overlaid thereon.

FIG. 5B is a simplified diagram of an example frame of video content, with content overlaid thereon.

FIG. 6 is a simplified block diagram of an example program schedule.

FIG. 7 is a flow chart of an example method.

### DETAILED DESCRIPTION

### I. Overview

A system can employ bonded cellular technology to transmit data from a transmitter to a receiver. For example, the transmitter can include a number of cellular modems that can transmit data to the receiver over one or more cellular networks. The cellular networks can include various networks provided by more than one carrier, such as Verizon, AT&T, T-Mobile, and Sprint, for instance. Before transmitting data from the transmitter to the receiver, the data can be parsed into a number of data packets. The data packets can then be allocated among the transmitter's cellular modems for transmission over their respective cellular networks. By parsing and transmitting the data in this manner, the data can be transmitted at a higher effective data rate than would be possible using only a single cellular modem. This can be desirable when transmitting large data files, such as video files or other media content. Thus, the system can employ bonded cellular technology to transmit media content from a client in communication with the transmitter to a server in communication with the receiver.

It can also be desirable to transmit metadata associated with the media content from the client to the server and/or from the server to the client. For example, metadata stored on the client can include data that describes or provides information about the media content. Based on the metadata, the server can perform various operations in connection with the media content. The metadata can be transmitted from the client to the server over the internet to an IP address of the server. For example, one of the transmitter's cellular modems can provide an internet access point for the client. Using the internet access point, the client can transmit the metadata associated with the media content to the server via the internet. Upon receiving both the metadata and the media content, the server can then perform various operations in connection with the media content based on its associated metadata.

In one example, the server can be part of a VPS. For instance, the server can take the form of one or more video servers of a VPS. The VPS can also include a scheduling system in communication with the server. The scheduling system can create and/or modify a program schedule, which serves as a schedule or outline of a video program during a given time period. The program schedule can include multiple records, each corresponding to one or more events. One common type of event is the playout of a video content item.

Thus, based on the metadata, the scheduling system can create and/or modify a program schedule that includes one or more records corresponding to the playout of the video content item transmitted from the transmitter to the receiver. For example, the metadata can include information associated with a location of the transmitted video content item, a start time indicating a time at which the VPS is scheduled to start playing out the video content item, and/or any other data associated with the video program item.

### II. Example Devices and Systems

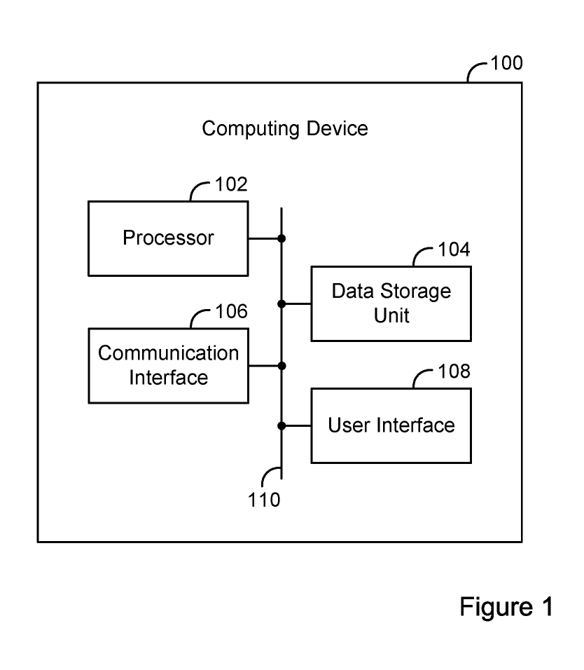

FIG. 1 is a simplified block diagram of an example computing device 100. Computing device 100 can perform various acts and/or functions, such as those described in this disclosure (including the accompanying drawings). Computing device 100 can include various components, such as processor 102, data storage unit 104, communication interface 106, and/or user interface 108. These components can be connected to each other (or to another device, system, or other entity) via connection mechanism 110.

As used in this disclosure, the term “connection mechanism” means a mechanism that facilitates communication between two or more devices, systems, or other entities. A communication mechanism can be a relatively simple mechanism, such as a cable or system bus, or a relatively complex mechanism, such as a packet-based communication network (e.g., the internet). In some instances, a connection mechanism can include a non-tangible medium (e.g., where the connection is wireless).

Processor 102 can include a general-purpose processor (e.g., a microprocessor) and/or a special-purpose processor (e.g., a digital signal processor (DSP)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application that can be executed in response to certain inputs being received from communication interface 106 and/or user interface 108, for instance. Data storage unit 104 can also store other types of data, such as those types described in this disclosure.

Communication interface 106 can allow computing device 100 to connect to and/or communicate with a device, system, or other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or Wi-Fi interface. Each connection described in this disclosure can be a direct connection or an indirect connection, the latter being a connection that passes through and/or traverses one or more devices, systems, or other entities, such as such as a router, switcher, or other network device.

User interface 108 can facilitate interaction with a user of computing device 100, if applicable. As such, user interface 108 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system.

Computing device 100 can take various forms, such as a workstation, a desktop computer, a laptop, a tablet, and/or a mobile phone.

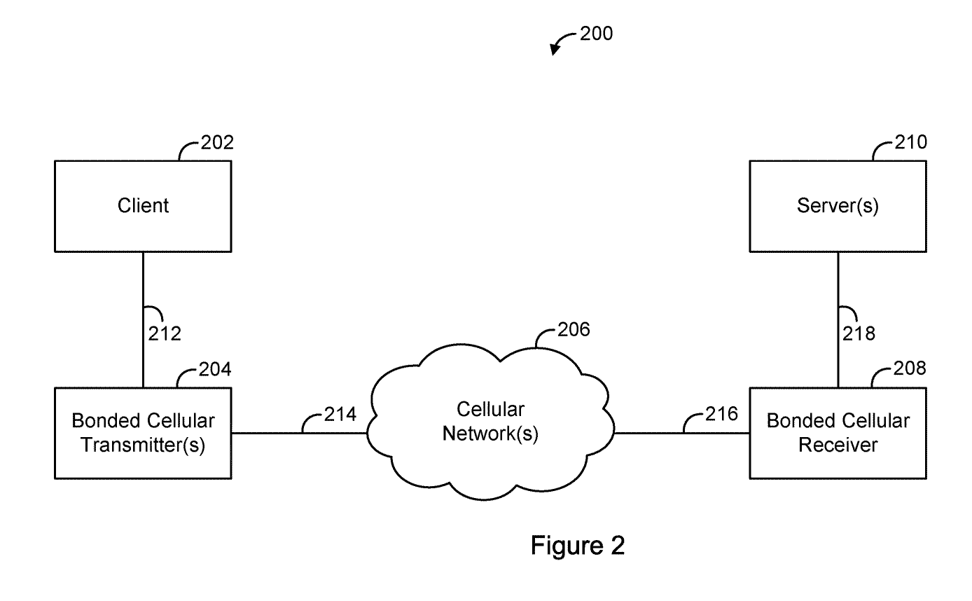

FIG. 2 is a simplified block diagram of an example system 200. System 200 can include various components, such as client 202, bonded cellular transmitter (BCT) 204, cellular network 206, bonded cellular receiver (BCR) 208, and server 210, each of which can be implemented as a computing system. In this disclosure, the term “computing system” means a system that includes at least one computing device. In some instances, a computing system can include one or more other computing systems. System 200 can also include connection mechanism 212, which connects client 202 with BCT 204; connection mechanism 214, which connects BCT 204 with cellular network 206; connection mechanism 216, which connects cellular network 206 with BCR 208; and connection mechanism 218, which connects BCR 208 with server 210.

Client 202 can take various forms, such as a workstation, a desktop computer, a laptop, a tablet, a video camera, and/or a mobile phone. BCT 204 can take various forms and can include various components, such as one or more cellular modems for communicating over one or more cellular networks. An example BCT is the LIVE+ EnGo or the LIVE+ GoBox provided by Dejero Labs Inc. of Waterloo, ON. Another example BCT is the LU500 provided by LiveU Inc. of Hackensack, N.J. Another example BCT is the Teradek Bond line of transmitters provided by Teradek, LLC of Irvine, Calif. Yet another example BCT is the TM8200 provided by TVU Networks Corporation of Mountain View, Calif.

Cellular network 206 can take various forms and can include one or more cellular networks operating in accordance with a particular radio access protocol, examples of which include, without limitation, Orthogonal Frequency Division Multiple Access (OFDMA) (e.g., Long Term Evolution (LTE) and Wireless Interoperability for Microwave Access (WiMAX)), Code Division Multiple Access (CDMA) (e.g., 1×RTT and 1×EV-DO), Global System for Mobile Communications (GSM), IEEE 802.11 (WiFi), BLUETOOTH, and others. The cellular networks can be provided by one or more cellular carriers, such as Verizon, AT&T, T-Mobile, and/or Sprint, to name a few.

BCR 208 can take various forms, such as a computing device that can receive and reconstruct bonded cellular data packet streams. An example BCR is the LIVE+ Transceiver provided by Dejero Labs Inc. of Waterloo, ON. Another example BCR is the LU2000 provided by LiveU Inc. of Hackensack, N.J. Another example BCR is the TVU Transceiver provided by TVU Networks Corporation of Mountain View, Calif. Yet another example BCR is a computing device running the Sputnik software provided by Teradek, LLC of Irvine, Calif.

Server 210 can take various forms, such as one or more media servers. An example media server is the K2 server provided by Grass Valley of San Francisco, Calif.

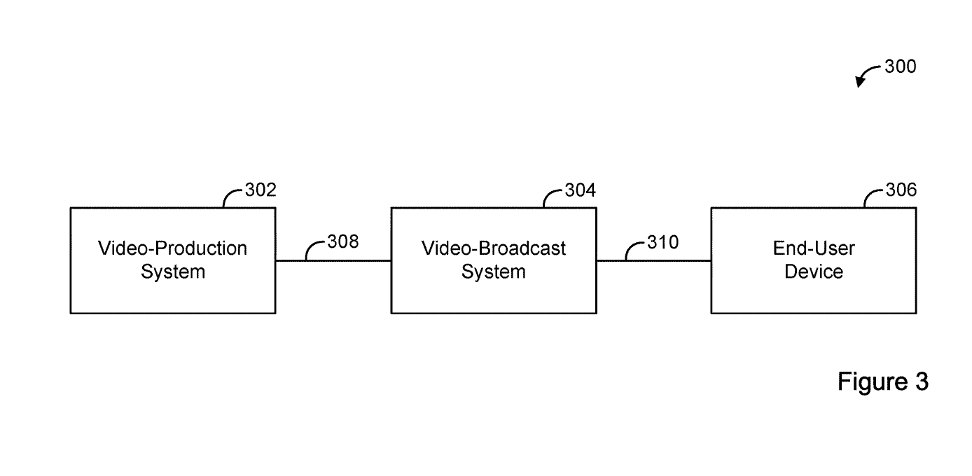

FIG. 3 is a simplified block diagram of an example video system 300. Video system 300 can perform various acts and/or functions related to video content, and can be implemented as a computing system.

Video system 300 can include various components, such as VPS 302, video-broadcast system (VBS) 304, and end-user device 306, each of which can be implemented as a computing system. Video system 300 can also include connection mechanism 308, which connects VPS 302 with VBS 304; and connection mechanism 310, which connects VBS 304 with end-user device 306.

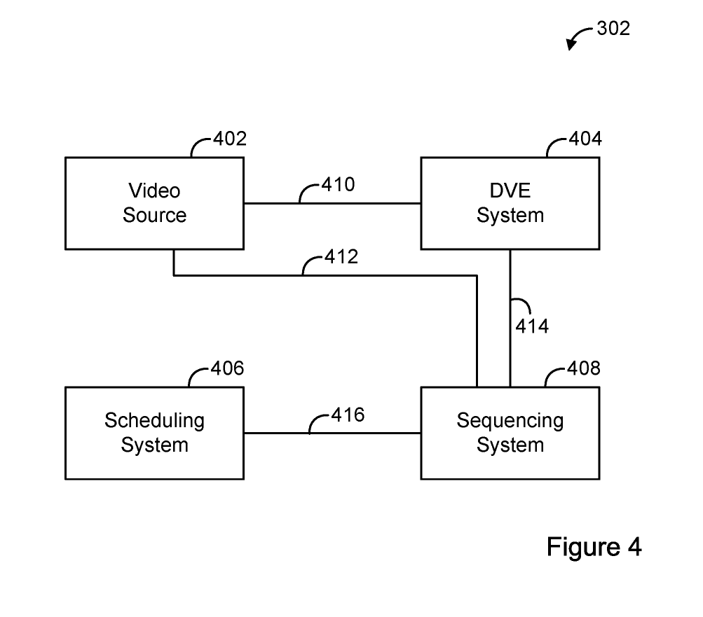

FIG. 4 is a simplified block diagram of an example VPS 302. VPS 302 can include various components, such as video source 402, digital video-effect (DVE) system 404, sequencing system 406, and scheduling system 408, each of which can be implemented as a computing system. VPS 302 can also include connection mechanism 410, which connects video source 402 with DVE system 404; connection mechanism 412, which connects video source 402 with sequencing system 408; connection mechanism 414, which connects DVE system 404 with sequencing system 408; and connection mechanism 416, which connects scheduling system 406 with sequencing system 408.

Video source 402 can take various forms, such as a character generator, a video server, a satellite receiver, a video camera, or a DVE system. An example character generator is the Viz Trio provided by Viz Rt™ of Bergen, Norway. An example video server is the K2 server provided by Grass Valley™ of San Francisco, Calif.

DVE system 404 can take various forms, such as a production switcher. An example production switcher is the Vision Octane production switcher provided by Ross Video Ltd. of Iroquois, Ontario in Canada.

VBS 304 can include various components, such as a terrestrial antenna or a satellite, each of which can be implemented as a computing system.

Each of the video-based entities described in this disclosure can include or be integrated with a corresponding audio-based entity. Likewise, the video content described in this disclosure can include or be integrated with corresponding audio content.

### III. Example Operations

System 200, video system 300, and/or components thereof can perform various acts and/or functions. These and related features will now be described.

System 200 can perform various acts and/or functions related to media content. For example, system 200 can receive, generate, output, and/or transmit media content. In this disclosure, the act of receiving, generating, outputting, and/or transmitting media content can occur in various ways and/or according to various standards. For example, the act of receiving, outputting, and/or transmitting media content can include receiving, outputting, and/or transmitting a media stream representing the media content, such as over Internet Protocol (IP) or in accordance with the high-definition serial digital interface (HD-SDI) standard. Likewise, the act of generating media content can include generating a media stream representing the media content. Also, the act of receiving, generating, outputting, and/or transmitting media content can include receiving, generating, outputting, and/or transmitting an encoded or decoded version of the media content.

Client 202 can receive, generate, and/or output media content, and can transmit the media content to BCT 204. Client 202 can receive (e.g., from a media source, such as a camera) media content, manipulate the media content (e.g., using video editing software), and store the media content (e.g., in the form of a file). Client 202 can then output the stored media content to BCT 204.

BCT 204 can perform various acts and/or functions related to transmitting media content. As noted above, BCT 204 can include multiple cellular modems that can transmit media content over one or more cellular networks to one or more destination devices. The cellular modems of BCT 204 can also receive data over one or more cellular networks from one or more source devices. For example, BCT 204 can include one or more modems that can communicate over a network provided by a first carrier, such as Verizon, one or more modems that can communicate over a network provided by a second carrier, such as AT&T, one or more modems that can communicate over a network provided by a third carrier, such as T-Mobile, and one or more modems that can communicate over a network provided by a fourth carrier, such as Sprint. In other examples, BCT 204 can include additional or fewer modems that can communicate over networks provided by additional or fewer carriers, as well as different carriers than those described herein.

In one example, BCT 204 can receive media content from client 202 and can parse the media content into a number of data packets. BCT 204 can then transmit the data packets through cellular network 206 to BCR 208. To improve the transfer rate of the media content from BCT 204 to BCR 208, BCT 204 can allocate transmission of the data packets among its multiple cellular modems. For instance, some of the data packets can be transmitted via one or more modems over a cellular network provided by a first carrier, while other data packets can be transmitted via one or more modems over a cellular network provided by a second carrier, and so on. The size and/or number of the data packets allocated to each cellular modem can be based on a maximum available bandwidth of each modem.

BCR 208 can perform various acts and/or functions related to receiving media content. As noted above, BCR 208 can include a computing device that can receive and reconstruct bonded cellular data packet streams. In one example, BCR 208 can receive the data packets transmitted by BCT 204 over cellular network 206. Based on the received data packets, BCR 208 can then reconstruct the media content from which the data packets were parsed. The reconstructed media content can then be stored in a data storage of BCR 208. Alternatively or additionally, the reconstructed media content can be transmitted to and stored in a data storage of server 210. In some examples, the data packets transmitted by BCT 204 may be first reconstructed elsewhere (e.g., a cloud-based server that reconstructs original files from data packets of bonded cellular transmissions), and then transmitted to BCR 208 and/or server 210 using a suitable wide area network.

In addition to receiving, generating, outputting, and/or transmitting media content, system 200 can receive, generate, output, and/or transmit metadata associated with the media content. The metadata can include any data that describes or provides information about the media content. For example, the metadata may include information related to categorizing and/or storing the file to which the metadata relates (e.g., media content) within a database of files.

In one example, client 202 can receive and/or generate metadata associated with the media content. For instance, client 202 can receive metadata associated with the media content via a user interface of client 202. Client 202 can then transmit the metadata to server 210. However, instead of transmitting the metadata using bonded cellular technology as described above with respect to transmitting the media content, the metadata can be transmitted over the internet to an IP address associated with server 210. As discussed above, BCT 206 includes a number of cellular modems that can communicate over cellular network 206. At least one of these modems can be configured to provide an internet access point (e.g., by providing internet connectivity of cellular network 206 to a Wi-Fi access point module) to client 202. By using the internet access point, client 202 can send data over the internet to server 210. Client 202 can thus transmit the metadata via the internet access point to an IP address of server 210.

In other examples, client 202 can transmit the metadata to server 210 over some other internet connection that is not provided by a cellular modem of BCT 204. For instance, client 202 can be connected to the internet via a router, an Ethernet connection, or a cellular modem separate from the cellular modems of BCT 204.

Server 210 can receive the metadata and can perform one or more operations to associate the received metadata with the media content. The operations can include storing the media content in a particular location indicated by the metadata, manipulating the media content in a particular manner as indicated by the metadata, and/or transmitting the media content to a particular destination as indicated by the metadata, among other possible operations.

Before performing the one or more operations on the media content, server 210 can receive an indication that the media content has been completely transmitted from BCT 204 to BCR 208. For example, BCR 208 can determine that the media content transmission is complete and responsively send an indication to server 210. Such a determination can include receiving a signal from BCT 204 indicating that there is no remaining media content to be transmitted. In other examples, BCT 204 can delete the media content from its data storage once the media content is transmitted to BCR 208. In these situations, BCR 208 can determine that transmission is complete based on determining that the media content has been deleted from the data storage of BCT 204. In any case, server 210 can perform the one or more operations on the media content responsive to receiving an indication that transmission of the media content from BCT 204 to BCR 208 is complete.

In some instances, an indication that transmission of the media content is complete can also be sent to client 202. For example, BCR 208 can send the indication to client 202 via cellular network 206 and/or server 210 can send an indication (e.g., responsive to receiving the indication from BCR 208) to client 202 via the internet. Responsive to receiving the indication, client 202 can display a confirmation message via its user interface indicating that transmission of the media content is complete.

In order for server 210 to perform the one or more operations on the associated media content based on the received metadata, the metadata can include an identifier of the associated media content. In one example, the metadata can include an identifier of a file name of the associated media content. For instance, client 202 can specify the file name of the media content to be transmitted to BCR 208, and the metadata can identify the file name. Upon receiving the metadata, server 210 can search one or more directories of BCR 208 for the file name identified by the metadata. In other examples, the metadata can include other various types of identifying information of the media content, such as file location or file size, among others.

Video system 300 can perform various acts and/or functions related to video content. For example, video system 300 can receive, generate and/or output a video program in the form of video content. In this disclosure, the act of receiving, generating, and/or transmitting video content can occur in various ways and/or according to various standards. For example, the act of receiving and/or transmitting video content can include receiving and/or transmitting a video stream representing the video content, such as over Internet Protocol (IP) or in accordance with the high-definition serial digital interface (HD-SDI) standard. Likewise, the act of generating content can include generating a video stream representing the video content. Also, the act of receiving, generating, and/or transmitting video content can include receiving, generating, and/or transmitting an encoded or decoded version of the video content.

VPS 302 can perform various acts and/or functions related to video content production. In this context, video source 402 can generate and/or output video content, and can transmit the video content to DVE system 404. As noted above, video source 402 can take the form of a character generator. A character generator can generate video content based on input data. For example, a character generator can receive weather data and then generate video content that includes the weather data. As another example, a character generator can use an ordered set of content items to generate video content that includes the content items in the specified order. This type of generated video content is sometimes referred to in the industry as a “ticker.” The content items can include various types of content, such as text and/or images. The ordered set of content items can be stored in various forms, such as in the form of an extended markup Language (XML) file.

As also noted above, video source 402 can also take the form of a video server. A video server can store video content (e.g., in the form of a file). Further, the video server can use the stored video content to generate a video stream representing the video content. This is sometimes referred to in the industry as the video server playing out the video content. The video server can then transmit the video stream, thereby transmitting the video content.

In some instances, one or more video servers of video source 402 can take the form of server 210, such that video content stored on a remote client can be transmitted to and stored in video source 402. For example, video content stored on client 202 can be transmitted by BCT 204 over cellular network 206 to BCR 208. Video source 402 can then retrieve the transmitted video content from BCR 208 and store the video content in a video server.

DVE system 404 can perform various acts and/or functions related to DVEs. For example, DVE system 404 can execute a DVE, thereby causing DVE system 404 to generate video content, and can transmit the video content to VBS 304.

In one example, DVE system 404 can receive first video content, and can execute a DVE, which causes DVE system 404 to generate second video content by modifying the first video content. As such, DVE system 404 can generate video content by modifying other video content.

DVE system 404 can modify video content in various ways, such as by overlaying text, images, video, and/or other content thereon. For example, DVE system 404 can modify video content by overlaying, on a lower right-hand corner region of the video content, a channel logo. As another example, DVE system 404 can modify video content by overlaying, on a lower-third region of the video content, a text box including text. As another example, DVE system 404 can modify video content by scaling or re-positioning the video content or a portion thereof.

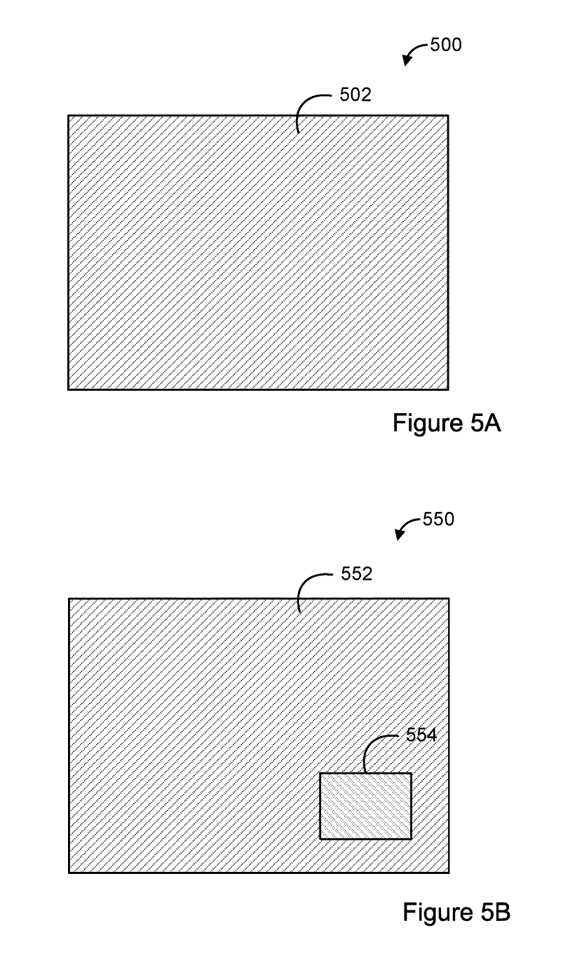

FIGS. 5A and 5B help illustrate the concept of overlaying content on video content. FIG. 5A is a simplified depiction of an example frame 500 of video content. Frame 500 includes content 502, but does not include content overlaid on content 502. For comparison, FIG. 5B is a simplified depiction of another example frame 550 of video content. Frame 550 includes content 552 and content 554 overlaid on content 552.

As noted above, DVE system 404 can execute a DVE, which causes DVE system 404 to generate video content by modifying other video content. However, in another example, DVE system 404 can execute a DVE, which causes DVE system 404 to generate video content without modifying other video content. This type of DVE is sometimes referred to in the industry to as a full-screen DVE.

DVE system 404 can obtain content for use in connection with executing a DVE in various ways. For example, DVE system 404 can retrieve the content from a data storage unit of DVE system 404. As another example, DVE system 404 can receive the content from video source 402.

In practice, DVE system 404 can execute multiple DVEs in serial fashion. Further, in practice, VPS 302 can include multiple video sources, and each of the multiple video sources can be connected to DVE system 404, and DVE system 404 can switch between one or more inputs as appropriate, perhaps to receive and use video content in connection with DVE system 404 executing a given DVE.

DVE system 404 can also perform other acts and/or functions related to DVEs. For example, DVE system 404 can create and/or edit DVEs, perhaps based on input received from a user via a user interface. When DVE system 404 creates a DVE, DVE system 404 can generate and store corresponding program instructions for later retrieval and execution. As such, the act of DVE system 404 executing a DVE can include DVE system 404 retrieving and executing program instructions corresponding to the DVE.

Scheduling system 406 can perform acts and/or functions related to scheduling and/or managing video content production. For example, scheduling system 406 can create and/or edit a program schedule of a video program, perhaps based on input received from a user via a user interface. Sequencing system 408 can then process records in the program schedule. This can cause sequencing system 408 to control one or more other components of VPS 302 to facilitate VPS 302 generating and/or outputting video content, which can serve as or be part of a video program. As such, based on a program schedule, sequencing system 408 can control video source 402, and/or DVE system 404.

A program schedule (sometimes referred to in the industry as a “rundown”) serves as a schedule or outline of a video program and can include multiple records. A video program can be conceptually divided into multiple logically-separated portions (sometimes referred to in the industry as “stories”). As such, each portion of the video program can be represented by a separate record of the program schedule. Each record can include various types of data.

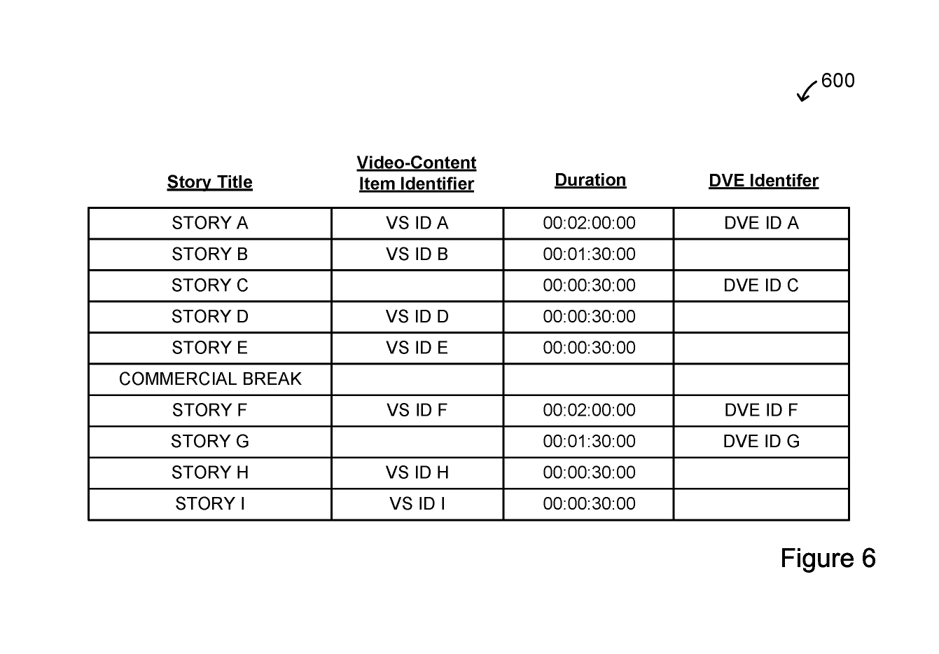

FIG. 6 is a simplified diagram of an example program schedule 600. Program schedule 600 includes ten records represented as ten ordered rows. Each record corresponds to a respective portion of a video program, except for one which corresponds to a commercial break. For each portion, the respective record specifies at least one data item that corresponds to that portion of the video program. In particular, each record specifies at least one of a story title, a video-content item identifier, a duration, and a DVE identifier (which can serve as an instruction to execute the identified DVE).

In some instances, a video-content item consists of logically-related video content. For instance, a video-content item can be a commercial or a portion of a television show that is scheduled between two commercial breaks.

As shown in FIG. 6, the first record specifies a story title of STORY A, a video-content identifier of VS ID A, a duration of 00:02:00:00 (in hours::minutes::seconds::frames format), and a DVE identifier of DVE ID A. As such, upon sequencing system 408 processing the first record, sequencing system 408 can cause video source 402 to playout a video-content item identified by the identifier VS ID A for two minutes, and further can cause DVE system 404 to execute a DVE identified by the identifier DVE ID A, which for example, can cause DVE system 404 to overlay content on the identified video-content item.

As another example, the third record specifies a story title of STORY C, a duration of 00:00:30:00, and a DVE identifier of DVE ID C. As such, upon sequencing system 408 processing the third record, sequencing system 408 can cause DVE system 404 to execute a DVE identified by the identifier DVE ID C, which for example, can cause DVE system 404 to generate and output a video-content item (in the form of a “full screen” DVE) for two minutes.

It should be noted that program schedule 600 has been greatly simplified for the purposes of illustrating certain features. In practice, a program schedule is likely to include significantly more data such as further details regarding DVE execution timing.

In some instances, scheduling system 406 can create and/or edit a program schedule based on video content and metadata received from a remote client. As discussed above, video content stored on client 202 can be transmitted by BCT 204 to BCR 208 and subsequently stored in video source 402. Additionally, metadata stored on client 202 associated with the transmitted video content can be transmitted from client 202 to scheduling system 406. For example, client 202 can transmit the metadata via the internet (e.g., through an internet access point provided by BCT 204 or through some other internet access point) to scheduling system 406.

The transmitted metadata can include various information that scheduling system 406 can use to create and/or edit a program schedule. For instance, the metadata can include a video content identifier (e.g., a file name, file location, etc.) of the transmitted video content, a program schedule identifier (e.g., a video program name, a video program time, etc.), a story identifier, timing data (e.g., a start time, a stop time, a duration, etc.), and/or a DVE identifier, as well as any other information related to the transmitted video content.

As discussed above, a user can input metadata through a user interface of client 202. For example, the user can input the video content identifier and any other metadata associated with the transmitted video content via the user interface of client 202. In some instances, the user interface can prompt the user to input various information, and the prompts can be based on data stored in the scheduling system 406. For example, client 202 can query scheduling system 406 for a list of program schedule identifiers (e.g., names of video programs). Based on the response from scheduling system 406, client 202 can then display the program schedule list to the user, and the user can select a program schedule from the list. Based on the selected program schedule, client 202 can then prompt the user for additional information. For example, client 202 can query scheduling system 406 for a list of stories associated with the selected program schedule as well as information indicating whether each particular story is associated with a video content item. Client 202 can then display the list of stories to the user indicating whether each story has an associated video content item, and the user can select a story from the list. Once the user has input the metadata, client 202 can transmit the metadata to scheduling system 406.

In some instances, client 202 can retrieve data from scheduling system 406 and store the data in a local cache so that client 202 does not need to repeatedly query scheduling system 406. For example, client 202 can retrieve a list of program schedule identifiers associated with a particular time frame (e.g., all program schedules for a particular day, week, etc.) as well as any information associated with each program schedule identifier, such as a list of stories associated with each program schedule. As such, client 202 can prompt the user for certain metadata as discussed above without querying scheduling system 406 between prompts.

Based on the transmitted metadata, scheduling system 406 can create and/or edit a program schedule of a video program. Scheduling system 406 can determine the video program identifier from the metadata and can edit a program schedule (e.g., program schedule 600) associated with the video program identifier. For example, scheduling system 406 can edit the program schedule to associate the video content identifier of the transmitted video content specified in the metadata with the story identifier specified in the metadata. Other types of data within the program schedule can be edited based on the metadata as well. For example, scheduling system 406 can also associate a duration and/or a DVE identifier with the specified story identifier based on the metadata.

Based on the program schedule, sequencing system 408 can then control one or more other components of VPS 302 to facilitate VPS 302 generating and/or outputting the transmitted video content, which can serve as or be part of a video program. As such, upon sequencing system 408 processing the record of the specified story identifier, sequencing system 408 can cause video source 402 to playout the transmitted video content item identified by the video content identifier specified in the metadata, and further can cause DVE system 404 to execute a DVE identified by a DVE identifier specified in the metadata, which for example, can cause DVE system 404 to overlay content on the identified video-content item.

In some instances, sequencing system 408 can be configured to process a next record in the program schedule based on a trigger event. In one example, the trigger event can include sequencing system 408 receiving input from a user via a user interface.

VBS 304 can transmit video content to end-user device 306 for presentation of the video content to an end user. In practice, VBS 304 can transmit video content to a large number of end-user devices for presentation of the video content to a large number of end users. VBS 304 can transmit video content to end-user device 306 in various ways. For example, VBS 304 can transmit video content to end-user device 306 over-the-air or via a packet-based network such as the internet.

End-user device 306 can receive video content from VBS 304, and can present the video content to an end-user via a user interface.

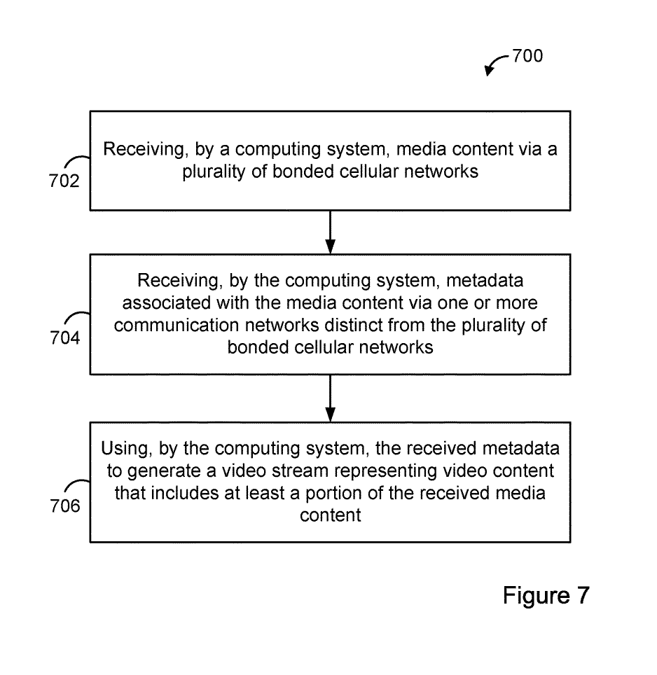

FIG. 7 is a flow chart illustrating an example method 700. At block 702, the method 700 can include receiving, by a computing system, media content via a plurality of bonded cellular networks. In one example, the computing system can include the BCR 208 and/or the server 210, each of which can be included as one or more components of the VPS 302.

Further, in line with the discussion above, the computing system can receive the media content from the client 202 and the BCT 204. For instance, the client 202 can receive (e.g., from a media source, such as a camera) media content, manipulate the media content (e.g., using video editing software), and output the media content to the BCT 204. The BCT 204 can then use multiple cellular modems to transmit the media content over one or more cellular networks to the BCR 208. In particular, the BCT 204 can parse the media content into a number of data packets and allocate transmission of the data packets among its multiple cellular modems.

At block 704, the method 700 can include receiving, by the computing system, metadata associated with the media content via one or more communication networks distinct from the plurality of bonded cellular networks. For instance, instead of using cellular bonding to receive the metadata over multiple cellular networks, the computing system can receive the metadata over the internet. In one example, one or more cellular modems of the BCT 206 can be configured to provide an internet access point to the client 202, and the client 202 can use the internet access point to send the metadata to the computing system. In other examples, the client 202 can transmit the metadata to the computing system over some other internet connection that is not provided by a cellular modem of the BCT 204 (e.g., via a router, an Ethernet connection, or a cellular modem separate from the cellular modems of the BCT 204).

At block 706, the method 700 can include using, by the computing system, the received metadata to generate a video stream representing video content that includes at least a portion of the received media content. In line with the discussion above, the metadata can include various information, such as include an identifier of the transmitted media content (e.g., a file name, file location, etc. of the media content), a program schedule identifier (e.g., a video program name, a video program time, etc.), a story identifier, timing data (e.g., a start time, a stop time, a duration, etc.), and/or a DVE identifier, as well as any other information related to the transmitted media content.

As such, the computing system can generate a video stream that includes at least a portion of the media content by creating and/or editing a program schedule of a video program. For instance, the scheduling system 406 can determine a video program identifier from the metadata and can edit a program schedule (e.g., program schedule 600) associated with the video program identifier. In one example, the scheduling system 406 can edit the program schedule to associate a media content identifier of the transmitted media content specified in the metadata with a story identifier specified in the metadata. In another example, the scheduling system 406 can additionally or alternatively associate a duration and/or a DVE identifier with the specified story identifier based on the metadata. Other examples are possible as well.

### IV. Example Variations

Although some of the acts and/or functions described in this disclosure have been described as being performed by a particular entity, such acts and/or functions can be performed by any entity, such as those entities described in this disclosure. Further, although the described acts and/or functions have been recited in a particular order, the acts and/or functions need not be performed in the order recited. However, in some instances, it can be desired to perform the acts and/or functions in the order recited. Also, not all of the described acts and/or functions need to be performed to achieve one or more of the benefits provided by this disclosure, and therefore not all acts and/or functions are required.

For instance, in some examples, the functions described in connection with client 202 and BCT 204 may be performed by respective modules of a single device, such as a video camera equipped with a built-in BCT and a user interface for receiving inputs that describe or otherwise categorize media content generated by such a device. In such an example, media content generated by the device (via its video camera) may be transmitted by the device (via its BCT) to a corresponding BCR while metadata associated with that media content (generated via the user interface) may be transmitted through a single modem of the BCT and/or separately transmitted.

Moreover, in some examples, the files (and associated metadata related to such files) transmitted between the BCT and the BCR and/or server may include files that are not media content. For instance, a database may be populated by a BCT sending a file to a corresponding BCR while metadata that specifies an organization of that file within the database is sent to a server. Based on the received metadata, the server may retrieve the file from the BCR and store it within the database in accordance with an organizational scheme specified by the metadata. Among other examples, such a system may be useful in populating an offsite backup database upon failure of a primary communication protocol (e.g., failure of a hard-wired wide area network).

Although certain variations have been discussed in connection with one or more examples of this disclosure, such variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method comprising:
receiving, by a computing system, media content via a plurality of bonded cellular networks;
receiving, by the computing system, metadata associated with the media content via one or more communication networks distinct from the plurality of bonded cellular networks; and
using, by the computing system, the received metadata to generate a video stream representing video content that includes at least a portion of the received media content.

2. The method of claim 1, wherein the computing system comprises a plurality of cellular modems, each cellular modem being configured to communicate over a respective cellular network of the plurality of bonded cellular networks, and wherein receiving the media content via the plurality of bonded cellular networks comprises receiving the media content via the plurality of cellular modems.

3. The method of claim 1, wherein the received metadata comprises a storage location for storing the received media content, and wherein the method further comprises storing the received media content in the storage location.

4. The method of claim 1, wherein using the received metadata to generate the video stream representing video content comprises:
modifying a program schedule based on the metadata; and
using the modified program schedule to generate the video stream.

5. The method of claim 4, wherein the received metadata comprises an identifier of the received media content, and wherein modifying the program schedule comprises modifying the program schedule to include the identifier of the received media content.

6. The method of claim 4, wherein the received metadata comprises timing information of the received media content, and wherein modifying the program schedule comprises modifying the program schedule to include the timing information of the received media content.

7. The method of claim 4, wherein the received metadata comprises an identifier of a digital video effect (DVE) associated with the received media content, and wherein modifying the program schedule comprises modifying the program schedule to include the identifier of the DVE associated with the received media content.

8. A computing system comprising:
a first communication interface for receiving media content via a plurality of bonded cellular networks;
a second communication interface for receiving metadata associated with the media content via one or more communication networks distinct from the plurality of bonded cellular networks; and
one or more processors configured to use the received metadata to generate a video stream representing video content that includes at least a portion of the received media content.

9. The computing system of claim 8, wherein the first communication interface comprises a plurality of cellular modems, each cellular modem being configured to communicate over a respective cellular network of the plurality of bonded cellular networks, and wherein the computing system is configured to receive the media content via the plurality of cellular modems.

10. The computing system of claim 8, wherein the received metadata comprises a storage location for storing the received media content, and wherein the one or more processors are further configured to store the received media content in the storage location.

11. The computing system of claim 8, wherein using the received metadata to generate the video stream representing video content comprises:
modifying a program schedule based on the metadata; and
using the modified program schedule to generate the video stream.

12. The computing system of claim 11, wherein the received metadata comprises an identifier of the received media content, and wherein modifying the program schedule comprises modifying the program schedule to include the identifier of the received media content.

13. The computing system of claim 11, wherein the received metadata comprises timing information of the received media content, and wherein modifying the program schedule comprises modifying the program schedule to include the timing information of the received media content.

14. The computing system of claim 11, wherein the received metadata comprises an identifier of a digital video effect (DVE) associated with the received media content, and wherein modifying the program schedule comprises modifying the program schedule to include the identifier of the DVE associated with the received media content.

15. A computing system comprising:
a transmitter system configured to:
obtain media content and metadata associated with the media content;
parse the obtained media content into a plurality of data packets;
transmit the plurality of data packets via a plurality of bonded cellular networks; and
transmit the obtained metadata via one or more communication networks distinct from the plurality of bonded cellular networks; and
a receiver system configured to:
receive the transmitted plurality of data packets via the plurality of bonded cellular networks;
reconstruct the media content using the received plurality of data packets;
receive the transmitted metadata via the one or more communication networks distinct from the plurality of bonded cellular networks; and
use the received metadata to generate a video stream representing video content that includes at least a portion of the reconstructed media content.

16. The computing system of claim 15, wherein the received metadata comprises a storage location for storing the reconstructed media content, and wherein the receiver system is further configured to store the reconstructed media content in the storage location.

17. The computing system of claim 15, wherein using the received metadata to generate the video stream representing video content comprises:
modifying a program schedule based on the metadata; and
using the modified program schedule to generate the video stream.

18. The computing system of claim 17, wherein the received metadata comprises an identifier of the reconstructed media content, and wherein modifying the program schedule comprises modifying the program schedule to include the identifier of the reconstructed media content.

19. The computing system of claim 17, wherein the received metadata comprises timing information of the reconstructed media content, and wherein modifying the program schedule comprises modifying the program schedule to include the timing information of the reconstructed media content.

20. The computing system of claim 17, wherein the received metadata comprises an identifier of a digital video effect (DVE) associated with the reconstructed media content, and wherein modifying the program schedule comprises modifying the program schedule to include the identifier of the DVE associated with the reconstructed media content.
